(19) United States
(12) Patent Application Publication
(10) Pub. No.: US 2015/0331657 A1
(43) Pub. Date: Nov. 19, 2015

(54) METHODS AND APPARATUS FOR AUDIO OUTPUT COMPOSITION AND GENERATION

(71) Applicant: CABER ENTERPRISES LIMITED, Lothian (GB)

(72) Inventors: Phil Bancroft, Edinburgh (GB); Tom Bancroft, Midlothian (GB)

(21) Appl. No.: 14/443,570

(22) PCT Filed: Nov. 19, 2013
(86) PCT No.: PCT/GB2013/053045

§ 371 Date: May 18, 2015

(30) Foreign Application Priority Data
Nov. 20, 2012 (GB) 1220849.2

(51) Int. Cl. G06F 3/16; G06F 3/0482; G06F 3/0484; G06F 3/0488

(52) U.S. Cl. CPC G06F 3/165; G06F 3/0488; G06F 3/0482; G06F 3/04842

(57) ABSTRACT

According to the invention there is provided a method of generating an audio output comprising the steps of: (a) providing one or more indicia representative of an audio sequence on a user interface; (b) detecting one or more user interactions with the user interface in a 15 physical space associated with the one or more indicia; (c) determining whether a timing of the one or more the user interactions corresponds with a timing of the audio sequence represented by the one or more indicia; and (d) dependent on the determination, outputting the audio sequence as an audio output.

### FIELD OF THE INVENTION

The present invention relates to methods and apparatus for composing and generating an audio output.

### SUMMARY OF THE INVENTION

According to a first aspect of the present invention, there is provided a method of generating an audio output comprising the steps of:

(a) providing one or more indicia representative of an audio sequence on a user interface;

(b) detecting one or more user interactions with the user interface in a physical space associated with the one or more indicia;

(c) determining whether a timing of the one or more the user interactions corresponds with a timing of the audio sequence represented by the one or more indicia; and

(d) dependent on the determination, outputting the audio sequence as an audio output.

Preferably, the method comprises the additional step of repeating steps (b) to (d) for a predetermined number of audio sequences.

The audio output may comprise a visual output (such as musical notation), an audible output (such as music listenable through speakers or headphones) or an audio file (e.g. for playback on a computer, portable music player or the like).

Preferably the user interface comprises a touch screen interface configured to display the indicia and receive the one or more user interactions. Alternatively, the user interface comprises a display device to display the indicia and a separate input device to receive the one or more user interactions.

Preferably, detecting one or more user interactions comprises detecting one or more taps within a predetermined area of the user interface. Preferably, detecting one or more user interactions comprises detecting one or more taps on or near the indicia.

Optionally, the method comprises the additional step of comparing the timing of the one or more user interactions with the timing of the audio sequence and determining a score representative of a user's timing accuracy.

Preferably, the method comprises the additional step of outputting an audible backing track corresponding to the timing of the audio sequence.

Additionally, or alternatively, the method comprises the step of providing an indicator on the user interface, said indicator appearing in the vicinity of the one or more indicia to indicate the timing of the audio sequence.

According to a second aspect of the present invention, there is provided a user interface configured to display one or more indicia and receive one or more user interactions, and to carry out the method of the first aspect.

Preferably the user interface comprises a touch screen interface. Alternatively, the user interface comprises a display device and an input device.

Optionally, at least a portion of the touch screen displays a virtual musical instrument. This may be (for example) a basic keyboard, full keyboard, or a xylophone. Alternatively, the input device comprises a virtual musical instrument.

According to a third aspect of the present invention there is provided a teaching environment comprising one or more input devices and one or more display devices, the one or more input devices and one or more display devices interconnected via a network and configured to carry out the method of the first aspect.

According to a fourth aspect of the present invention, there is provided a method of generating an audio sequence comprising the steps of:

(a) displaying a user interface;

(b) receiving an arrangement of indicia representative of the audio sequence via the user interface;

(c) detecting one or more user interactions with the user interface in a physical space associated with the one or more indicia;

(d) determining whether a timing of the one or more the user interactions corresponds with the audio sequence represented by the one or more indicia; and

(e) dependent on the determination, outputting the audio sequence as an audio output.

Optionally, the method comprises the additional step of receiving an indication of one or more pitch values to be associated with the audio sequence represented by the indicia. Additionally, or alternatively, the method comprises the additional step of receiving one or more lyrics to be associated with the audio sequence represented by the indicia.

Optionally, the method further comprises the step of converting the indicia, the indicia and the pitch values, the indicia and the lyrics, or the indicia and the pitch values and the lyrics, into musical notation and displaying said musical notation on the user interface. Alternatively the musical notation is output as an electronic file.

Embodiments of the fourth aspect of the present invention may comprise one or more features corresponding to those of the first aspect.

According to a fifth aspect of the present invention, there is provided at least one computer program comprising program instructions which, when loaded onto at least one computer, cause the computer to perform the method of the first or the fourth aspect.

According to a sixth aspect of the present invention, there is provided at least one computer program comprising program instruction which, when loaded onto at least one computer, cause the at least one computer to act as a user interface according to the second aspect or the teaching environment of the third aspect.

Preferably, the at least one computer program of the fifth or the sixth aspect are embodied on a recording medium or read-only memory, stored in at least one computer memory, or carried on an electrical carrier signal.

### BRIEF DESCRIPTION OF THE FIGURES

The present invention will now be described by way of example only and with reference to the accompanying figures in which:

FIG. 1 illustrates a shape notation employed in embodiments of the present invention;

FIG. 2 illustrates an element of a graphical user interface being used in a composition process in accordance with embodiments of the present invention;

FIG. 3 an element of a graphical user interface displaying an exemplary musical composition in accordance with embodiments of the present invention;

FIG. 4 illustrates a form comprised in a graphical user interface for a composition process in accordance with embodiments of the present invention;

FIG. 5 illustrates an “idea” and a variation on the “idea” composed in accordance with embodiments of the present invention;

FIG. 6 illustrates an “idea” an a “resolution” associated with the “idea” composed in accordance with embodiments of the present invention;

FIG. 7 illustrates the selection of a “hi” and a “low” pitch variation in accordance with embodiments of the present invention;

FIGS. 8 to 13 illustrate the steps of composing a rhythm, assigning pitches to the rhythm, adding lyrics and finally converting same to conventional musical notation, in accordance with embodiments of the present invention;

FIG. 14 illustrates the conducting of a rhythm and the generation of an audio output in accordance with embodiments of the present invention;

FIGS. 15 and 16 illustrate exemplary input devices in accordance with embodiments of the present invention;

FIGS. 17 to 20 illustrate a teaching function which teaches musical notation in accordance with embodiments of the present invention;

FIG. 21 illustrates an alternative teaching function in accordance with embodiments of the present invention; and

FIGS. 22 and 23 illustrate a further alternative teaching function in accordance with embodiments of the present invention.

### DETAILED DESCRIPTION OF THE INVENTION

The present invention provides a user with an innovative way of learning to read and understand musical notation as well as an innovative way of composing a piece of music.

Embodiments of the present invention allow a user to develop an accurate performance of a musical composition, for example for educational or recording purposes. This may be achieved by a step-wise process facilitated by the present invention of composition, reading notation, conducting and performing the composition on a musical instrument (virtual or real). Embodiments of the present invention also enable users to develop improvisational skills (i.e. real-time composition) and record or otherwise store the composition or performance as a unique piece of music.

The invention facilitates a relationship between a user, a teacher (who is teaching the user to compose and play music), a touchscreen/smartboard and interface, musical notation (with which user composes music), computer, instruments (on which user and class plays composed music) and classmates (with whom user is learning to both compose and play music).

Furthermore, embodiments of the present invention allow a user to progress through a series of progressively more difficult steps, with each individual step being quite small. There is a resulting skill overlap bonus effect, learning composing teaches conducting, and learning conducting teaches part of reading notation, reading the notation teaches a big part of performing on the instrument. The end result of a group learning to compose, notate, read, and perform, creates—in a group situation—an outcome where many positive things can happen in the classroom in a way that uses the relationship between smartboard, teacher, and class in a very powerful way.

Also disclosed below is a method of producing a performance score and/or feedback score for a user which provides a quantitative measurement. In addition, embodiments of the invention can provide a recording process, so that performances can be recorded, and distributed—e.g. made available on a website as an mp3 file or burned onto a CD or other distributable media.

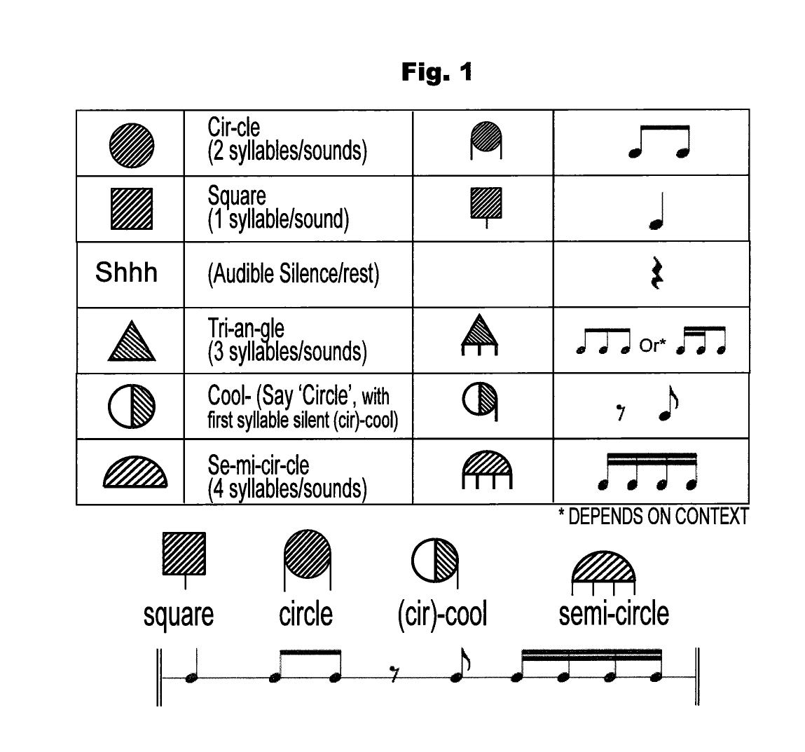

With reference to FIGS. 1 to 3, there follows an outline of the compositional process, with an example of the graphical interface, as used on an exemplary touchscreen device.

FIG. 1 illustrates the shape notation employed by embodiments of the present invention. The notation (in which indicia represent one or more rhythms) works as follows:

Each shape/symbol represents a rhythm lasting one beat expressed by the number of syllables in the shape name. So the number of sounds in the table reflects the number of sounds per beat—giving a clear rhythmic notation. In this way, each indicia represents an audio sequence, be it one rhythm, two rhythms, three rhythms and so on.

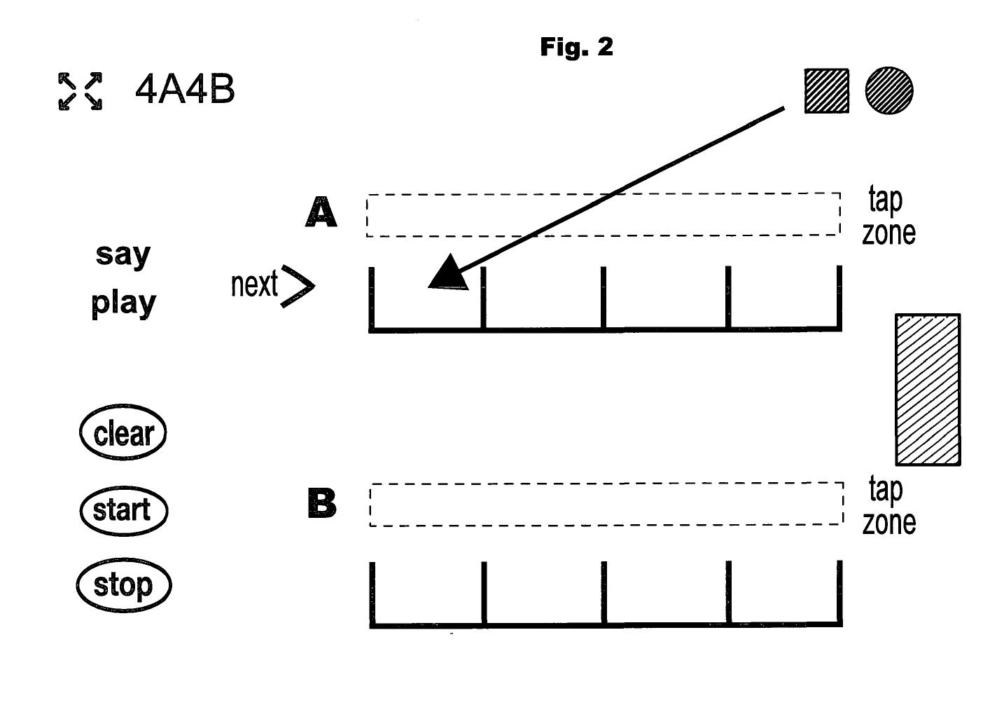

FIG. 2 illustrates how a composition is constructed using the graphical user interface of embodiments of the present invention, and the above-mentioned shape notation.

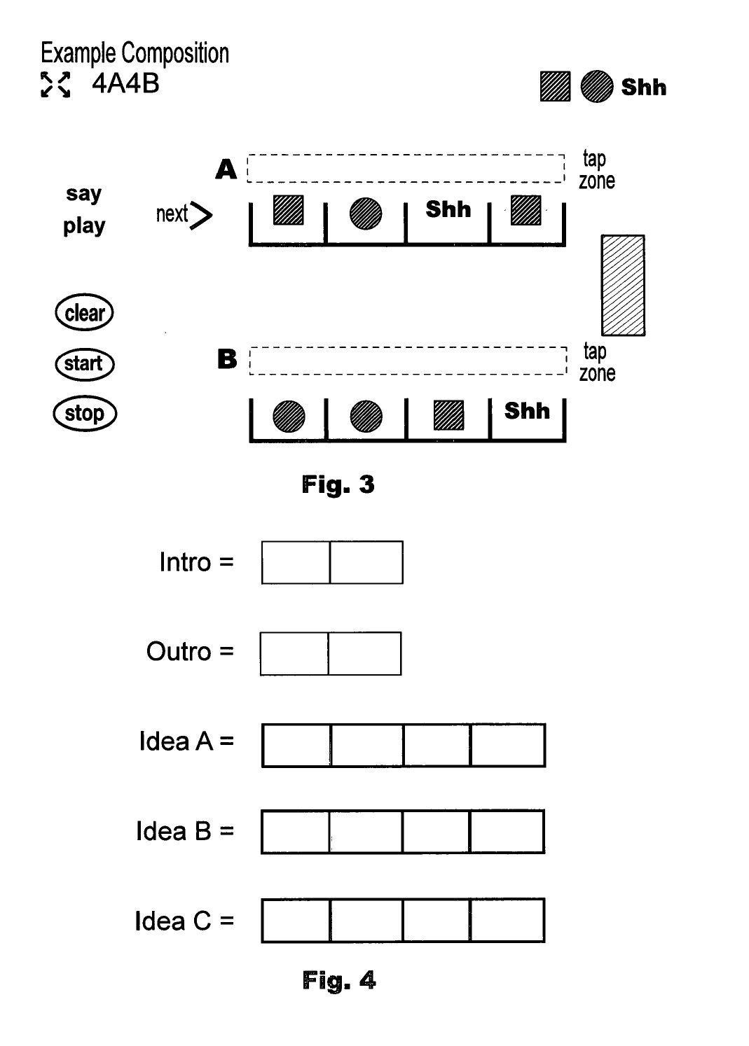

A user composes two short rhythmic sequences, called “Idea A” and “Idea B” by click-dragging shapes and dropping onto two grids—made up of a 4 box “Idea A” grid and a 4 box “Idea B” grid. Each box represents a beat—so 4 boxes equals one bar/one measure of 4 beats (4/4) in musical terms. FIG. 3 shows an example composition in which “Idea A” and “Idea B” have been populated with shape notation indicia.

Examples of grid variants include 3 boxes equalling a 3 beat bar (¾), or 2 bar ideas (i.e. A=2 bars of 4 boxes/beats each, total 8, or 2 bars of 3 boxes/beats each, total 6).

Ideas A and B (in this example) are the same size but contain different sounds (or the same sounds in a different sequence). In more complex compositions there may be a 3rd discrete idea C. The Pattern of As and Bs is given at the top left of the interface—here 4A4B (4×A then 4×B). This reflects the number of times and the order in which Idea A and Idea B will be performed to create a “Phrase”. These patterns are preset, chosen from a pre-defined list, or made up and inputted by the user.

In further variants, additional Phrases can be created from Ideas A and B, or by creating a third or fourth Idea (C and D) using identical methods and then composing two or more Phrases, named Phrase B and Phrase C, each comprised of a short sequence of Ideas e.g. Phrase [symbol] =Idea C Idea C Idea A Idea B.

Further variants may include creating a pattern of Phrases to create a song form pattern, for more complex and sophisticated compositions—e.g. [symbol] —i.e. Phrase [symbol] Phrase [symbol] Phrase [symbol] Phrase [symbol] . For the purposes of the description and examples herein when a letter refers to a Phrase it will be in a box, when it refers to an Idea it won't.

Other variants include; a 2 beat intro—a short 2 beat Idea that contains a sequence of 2 sounds from elsewhere in the composition which is repeated (usually 8 times) at the start of the piece; and a 2 beat outro—a short 2 beat idea that contains a sequence of 2 sounds from elsewhere in the composition which is repeated (usually 8 times) at the end of the piece.

A further level of complexity occurs with what we shall refer to as “Variation” and “Resolution” Ideas.

The user may be presented with a preset form (as illustrated in FIG. 4) containing the indicated boxes to fill in with notes or sounds (N.B. the sounds may be just words or rhythms, but may be rhythms and pitches). The user may also be presented with boxes for “Idea A_{V}” (“A variation”) and/or “Idea A_{R}” (Resolution).

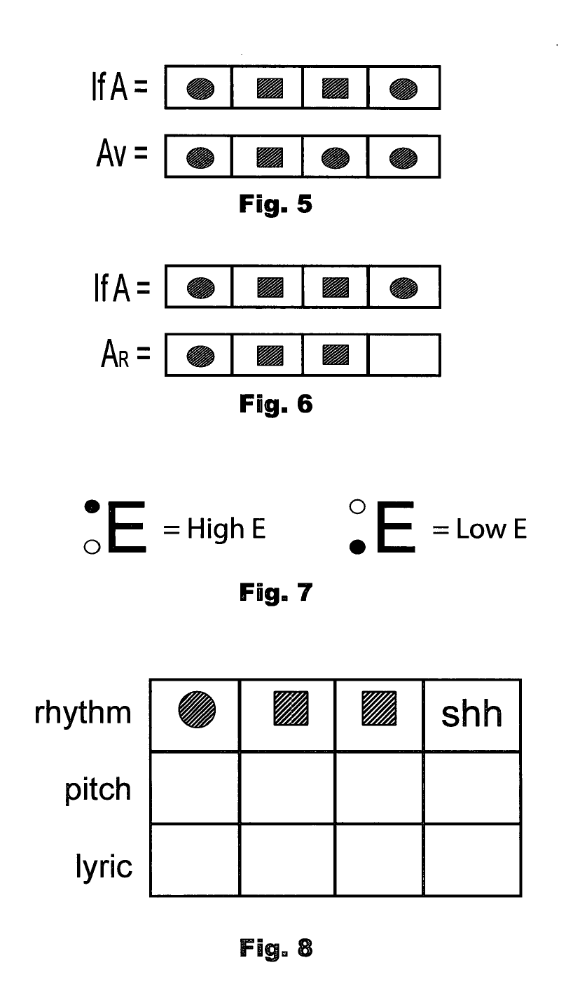

Variation is defined as “same but different”. “A variation” will be identical to Idea A except that one of the 4 boxes is different in its content—either rhythmically, in pitch or on both. See FIG. 5 for example.

A resolution idea is used at the end of a phrase, so whether it is A, B or C will depend on which of these ideas occurs at the end of the phrase (e.g. in the case of AABA AABA CCCC AABA_{R} it will be A_{R} as it occurs last in the sequence). It is also possible to have a resolution phrase at the end of each 4 idea grouping i.e. (AABA_{R} AABA_{R} CCCC_{R} AABA_{R}).

A resolution idea creates a feeling of ending, like a comma or full stop. Idea A_{R} is the same as Idea A except that it is shortened (see FIG. 6). The last beat is altered to be a rest or a SHH. If it is already a rest or SHH then the third beat is made into a Rest or SHH and so on. In the rare occasion where Idea A has rests or a SHH on beats 2, 3 and 4 then Idea A_{R} would either: repeat the sound on Beat 1 on Beat 2 to create a feeling of resolution, or Idea A_{R} would be completely empty.

The next step is pitch composition. Users compose by pitch by choosing from a limited pitch palette—in an embodiment of the present invention the number of pitch choices increases as the student goes through a sequence of activities in a teaching course.

A starting point may be composing with “Hi” and “Lo” sounds (i.e. 2 pitches). This may be represented using a Hi Lo Stave.

There will be a sequential increasing of number of pitches through (for example):

3 pitches

4 pitches

5 pitches

. . .

up to 12 pitches.

Pitch choice is achieved graphically using note letters e.g. C means note pitched at C, D means note pitched at D etc, and for each letter the user will be able to choose from 2 or more octaves, by click selecting an octave circle next to the letter (see for example FIG. 7). (NB within the graphical user interface the font for note pitch is preferably different to the font used for Idea or Phrase letters)

FIGS. 8 to 13 describe the composition of a piece of music using the graphical user interface of embodiments of the present invention.

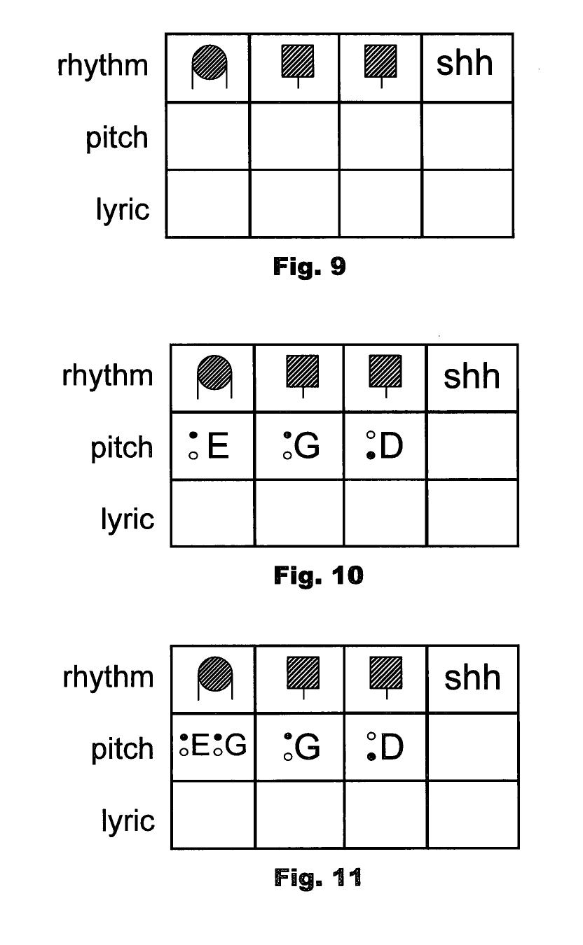

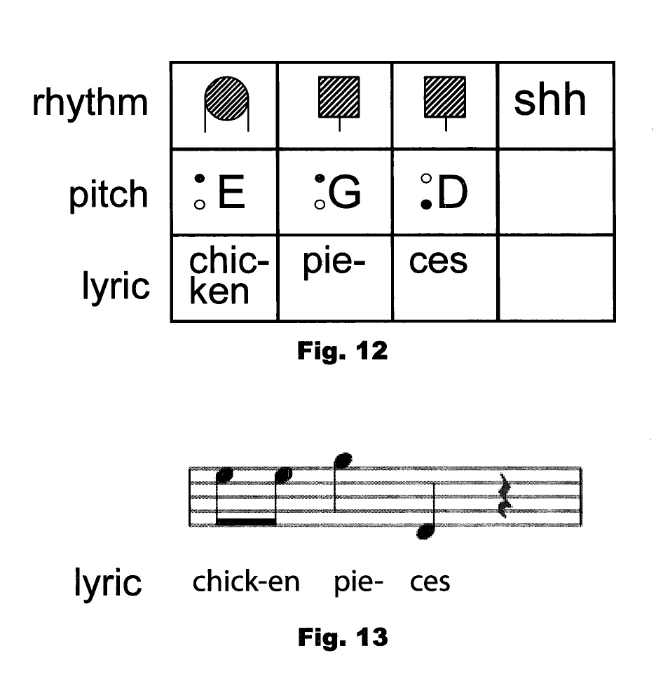

In FIG. 8, the shape rhythm is composed; in FIG. 9 (optional) sticks are added by pressing, for example, an “add sticks” button; in FIG. 10 the pitch is chosen (one pitch letter per box in this example) by selecting “Hi” or “Lo” or alternatively in FIG. 11 the pitch is chosen for each individual rhythm; FIG. 12 shows the addition of lyrics (one syllable per stick) and finally FIG. 13 shows how the shape notation can be converted to conventional musical notation.

Note that when using 3 to 12 note pitch sets, there may be an accompanying process whereby 2 to 4 note chord accompaniments are composed to go with the melody.

The next step in the teaching sequences is that of “conducting”.

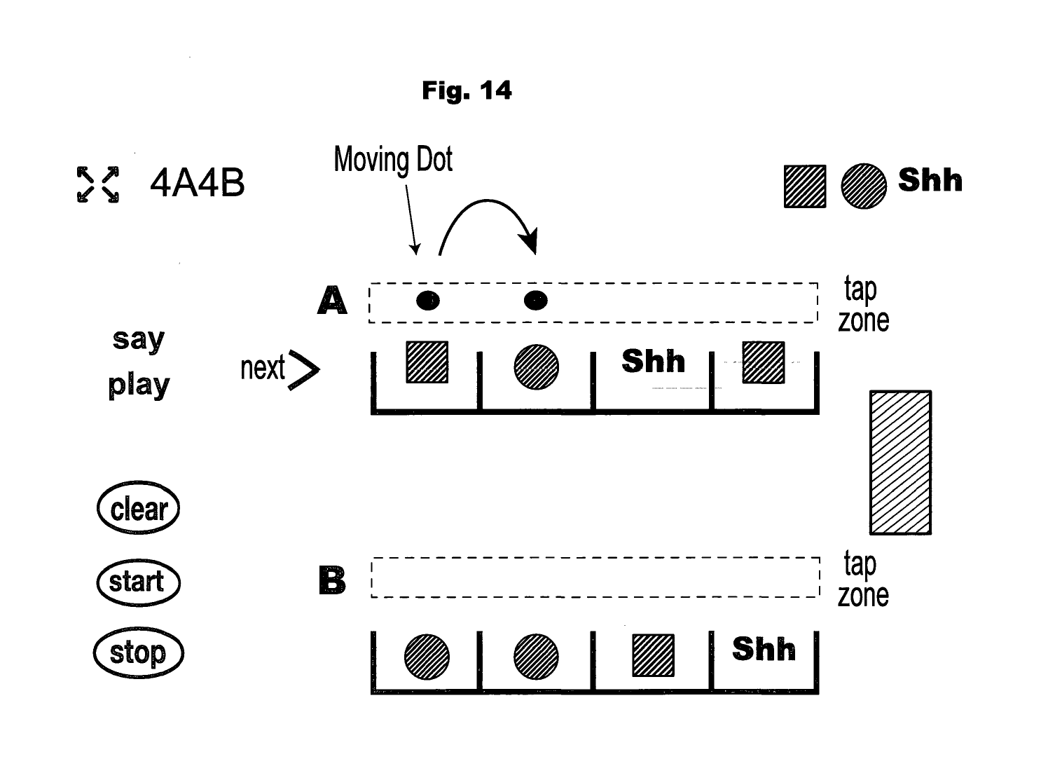

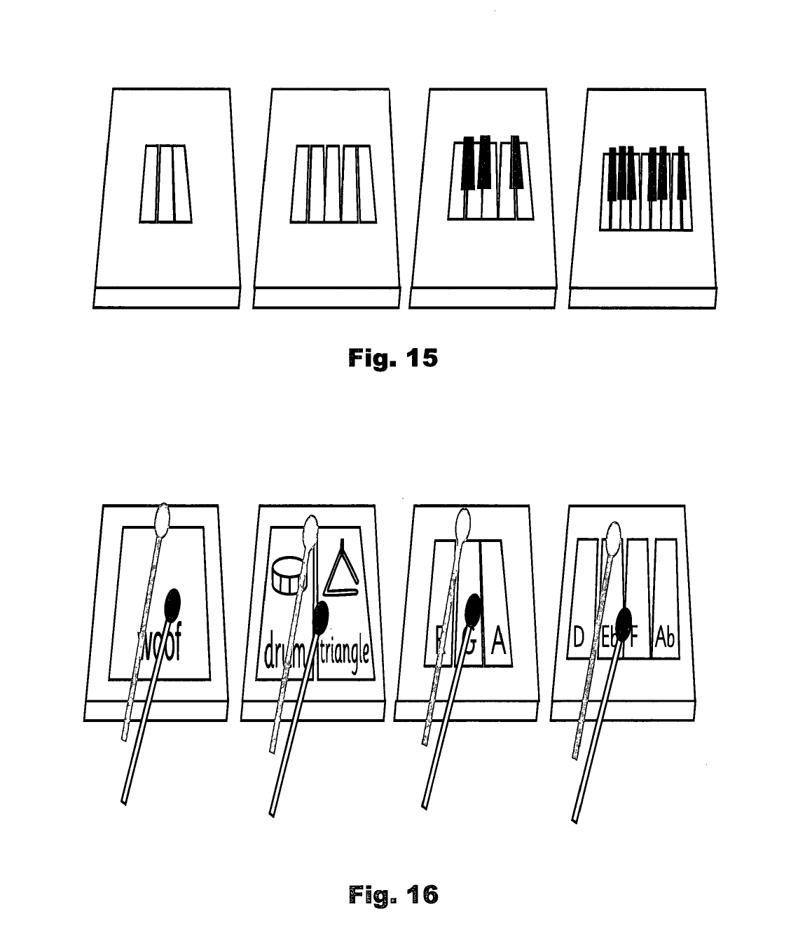

On pressing “Start” (see FIG. 1 or 2, or indeed FIG. 14 to which the following refers), the device plays a backing drum groove and indicates to the user the sequence of Ideas to be performed and marks off successive boxes/beats within in each idea, in time with the backing groove—but does not play the composition itself (i.e. the contents of the boxes), as generally indicated in FIG. 14. (Of course, the device may not play the backing groove but only display the indication, or vice versa).

The computer indicates the sequence by a small dot appearing above the correct box in time with the backing groove. The form is marked on the screen and may be user selectable. if 4A4B—then the device will indicate, using backing track and moving dot, that the A grid is performed 4 times in a row left to right, with an equal gap between each box including when looping back from the last box to the first box on repeating. After 4 loops of A the dot and backing track will indicate the shift to B (including a voice on the backing track saying “B”) and the dot will move from the last box of A to the first box of B with the same gap as between any other box.

NB The speed/tempo may be chosen by clicking on slow, med, fast buttons or using a tempo slider. The conducting skill, which correlates exactly to the musical skill of conducting a group of musicians to play a similar composition when written out on a paper handout, involves counting in and then tapping on the screen exactly when and where the dot falls. This is indicated as a “tap zone”.

The conducting skill is effectively achieved if the user taps once per beat (box) in the tap zone above the correct box in a sequence defined by the chosen AB pattern. Basically a user taps once on the dot each time it appears and it will show the sequence that corresponds to the AB pattern shown on the screen.

As an optional additional feature the screen will be able to measure when and where the user tapped and gave a running score based on rhythmic accuracy of the tapping, in relation to the timing of the backing groove and the dot appearing and the correct following of the A/B pattern. This score could be stored in a league table, for example.

In addition to learning and performing the important conducting skill, the tap zone functionality of the touch screen adds in an additional beneficial step.

The conductor tapping once in the tap zone above each box causes the device to perform the contents of the box in the correct sequence. In basic terms—whatever the symbol in the box means, the device will play that if you tap once above the box in the “tapzone”. If the tapzone is tapped in a rhythmically accurate way the contents of the box (square—1 sound) circle (2 sounds) will be performed by the device correctly in a way that fits with the backing track and the tempo.

This achieves two things; a) it gives the conductor audible feedback as to whether they are tapping in time i.e. conducting accurately, and b) the user hears a performance of their composition, thus allowing them to learn what the notation means, and so it enables teaching of musical notation.

In the described embodiment there are 2 clickable options to select “Say”-meaning the contents of the box will be performed as a word e.g. ‘Square’ or ‘Circle’, or “Play”—meaning the content of the box may be performed as the rhythm played on an instrument e.g. woodblock. NB The contents of the box and user interface for the composer may involve pitch information, and so tapping once on the tap zone when ‘Play’ is selected performs the rhythm defined by the shape, plus the correct pitch as defined by letters e.g. A, B, C, D, E etc if selected.

There may also be provided a DEMO button where the device will play the composition in full without need for user interaction. This allows the user to realise what the composition should or will sound like.

The next challenge/level for the user is that they begin to play in the sequence defined by the backing track AND the moving dot, but instead of tapping in the tap zone as before (where only one tap per beat is required), the user has to tap the rhythm of each symbol actually ON the symbol itself. This will produce the sound—the notation has become also the instrument, an instrument that is laid out exactly in sequence with the composition—because it IS the composition.

However to perform the rhythm correctly in this situation the user will need to tap once in time with the beat on a square, and twice in time with the beat on a circle, i.e. they will need to be able to read and understand the notation in order to play the notation as an instrument correctly. Again this performance could be scored.

NB In a learning sequence preceded by the “tap zone” step, the user has heard the correct rhythm by tapping once per beat in the tap zone, and now the user must tap the correct number of times, in time with the beat, on each symbol in the right sequence to generate the correct audio output.

Where pitch is used, and only during the simple pitch level when only one pitch letter per box is allowed, tapping on the symbol (for example ‘circle) in a box will play a single note of the correct pitch. So to perform the composition correctly the user will have to tap on the circle twice to perform the correct pitch with the correct rhythm.

Whilst the user is tapping in the tap zone, or tapping on the playable notation, it is an option of an embodiment of the present invention to display a picture of an online instrument or instruments, flashing in time with the composition, with the correct instrument flashing (e.g. chime bar for pitch G) when that instrument should be played.

The user can then start to tap the rhythm previously played on the notation, actually on the online instruments—using the right rhythm and pitch. Now the user is visually following the notation and the moving dot, but clicking on one to three (for example) onscreen instruments. Again this could be recorded and the accuracy scored and fed back. This is now teaching actual reading of music notation and performance.

FIG. 15 and FIG. 16 illustrate examples of “iPercussion” instruments which are digital boxes with touch sensitive screens, played by tapping with fingers or hitting with light beaters. Such instruments may form part of a large networked teaching environment. Each “iPercussion” instrument can be set to display a number of trigger areas (e.g. like digital chime bars) each with a pitch set and sound set. The pitch and sound sets may comprise animal noises, themed sounds and words, samples/recordings, melody, chord, bass and groove/drum parts. Pitch sets can changes as the performance progresses through a chord sequence.

It is therefore only a small step now to follow a shape notation composition on the screen while playing the composition on a real instrument. This can involve (in such a teaching environment as mentioned above) the whole class and a conductor may continue to point in the tap zone to help the class members to follow the sequence. The only difference in this example is that the performance can't be easily scored and recorded by the device, although it is foreseen that microphone and/or other sensor inputs may be employed to receive feedback from a real instrument or instruments.

Shape notation has many advantages but embodiments of the present invention employ it to ultimately teach conventional music notation. To help this, once a piece has been composed one can press a “conventional notation” button, whereupon the shape notation would be joined by the same composition in conventional notation. See the example that follows for an example of the shape to conventional notation button being pressed.

An embodiment of the present invention includes a musical education system comprising such “iPercussion” instruments (or the like). Each participant may have an instrument or learning base (device), wirelessly connected (or otherwise) to a network with a central controller. Of course, there may be a number of controllers or the central controller may be distributed across several of the instruments or learning bases (devices).

Participants can play and practice with headphones (set either to listen to the individual participant or to a group etc.). This way, individuals, groups of individuals or entire classes may interact or practice in conjunction with exercises which may be shared across many or all devices. The central controller can program or provide the individual devices with sound sets, activities and the like. Performance of the activities on, for example, mini-keyboards may be facilitated by communication links between said instruments and the teaching devices.

Video footage, primarily for teaching purposes, may also be provided via the devices. The devices may also be pre-loaded with “templates” comprising ideas, phrases, sound sets, or any other information/teaching content as desired. A teacher may have overview of groups and/or individuals' output via a central location and provide feedback to the groups or individuals. On-board cameras allow images or video of a user to be recorded as part of the learning process for later viewing. Exemplary performances may be shared across devices for teaching and/or entertainment purposes.

There follows description of an alternative embodiment of the present invention.

Improvisation, in musical terms, is real-time composition. Embodiments of the present invention can be used usefully to train children (or indeed adults of course) by way of an improvising “game” for two players termed “Repeat, Alternate, Jumble”.

Initially the two participants follow the moving dot (see previously described embodiments) to perform a call and response pattern that is pre-composed. By tapping in the tap zone they grow to understand what they need to play. It also establishes the idea that a) one participant plays a call, and the other participant copies back the response. Initially a preset shape rhythm is performed on both sides.

After a count in the dot passes through the tap zone once on the left side and if the user 1 taps the precomposed sequence will be performed. Immediately afterwards if user 2 taps in the response tap zone the precomposed sequence will be performed AGAIN the same. With one pitch choice the mode is called ‘Repeat’.

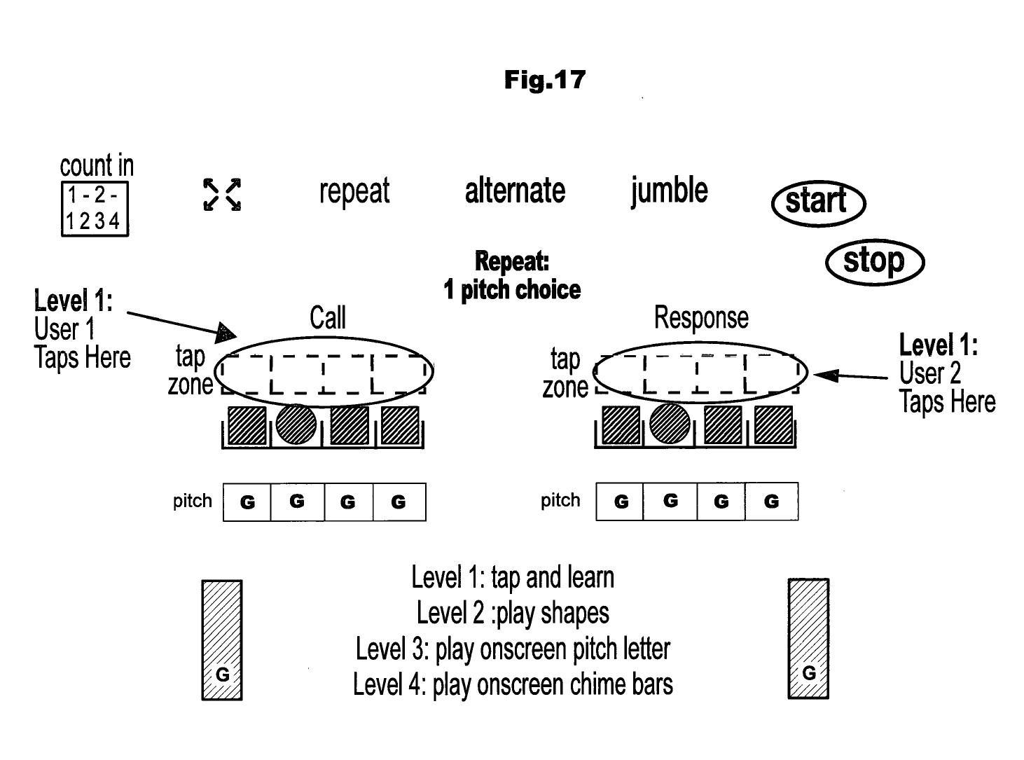

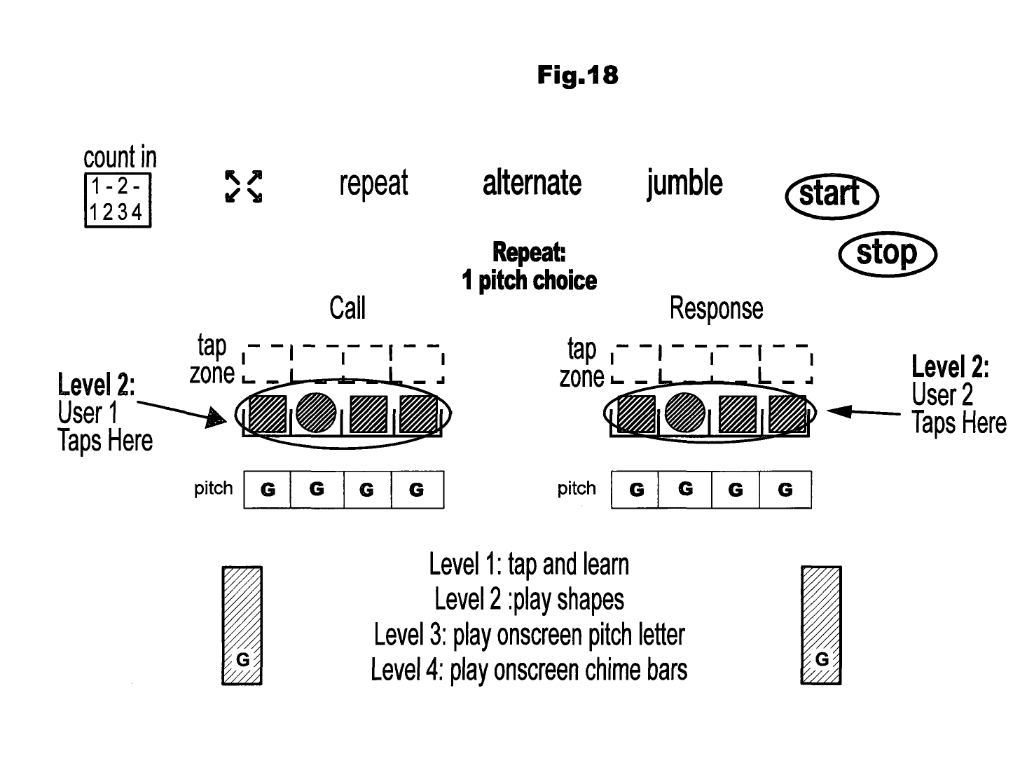

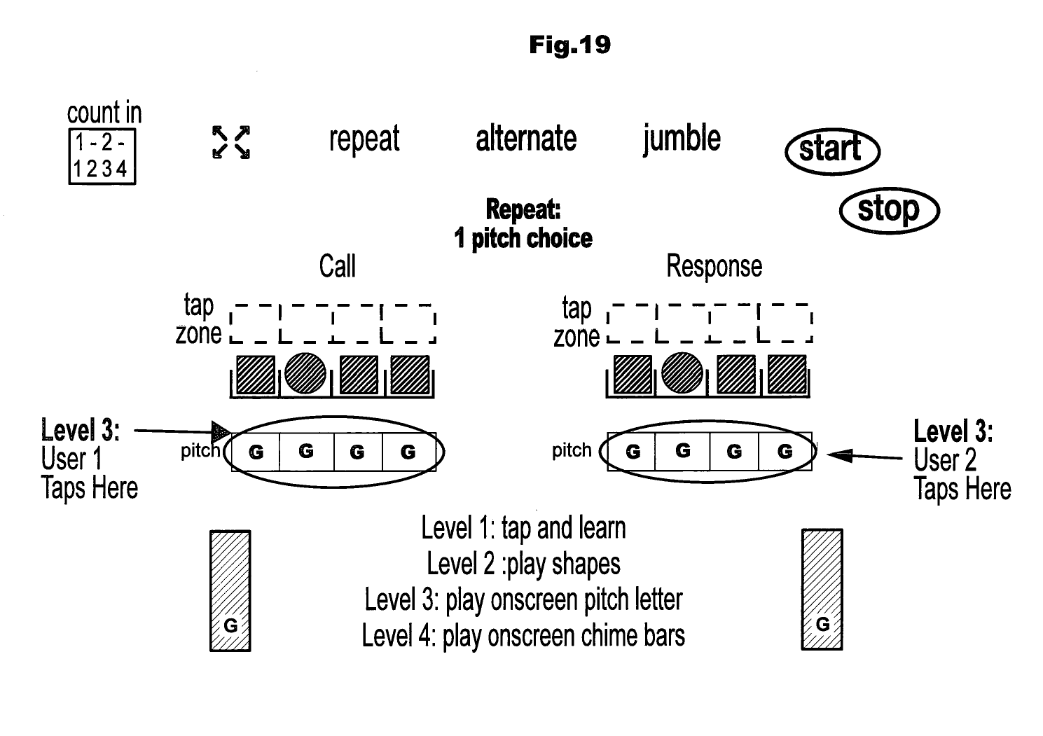

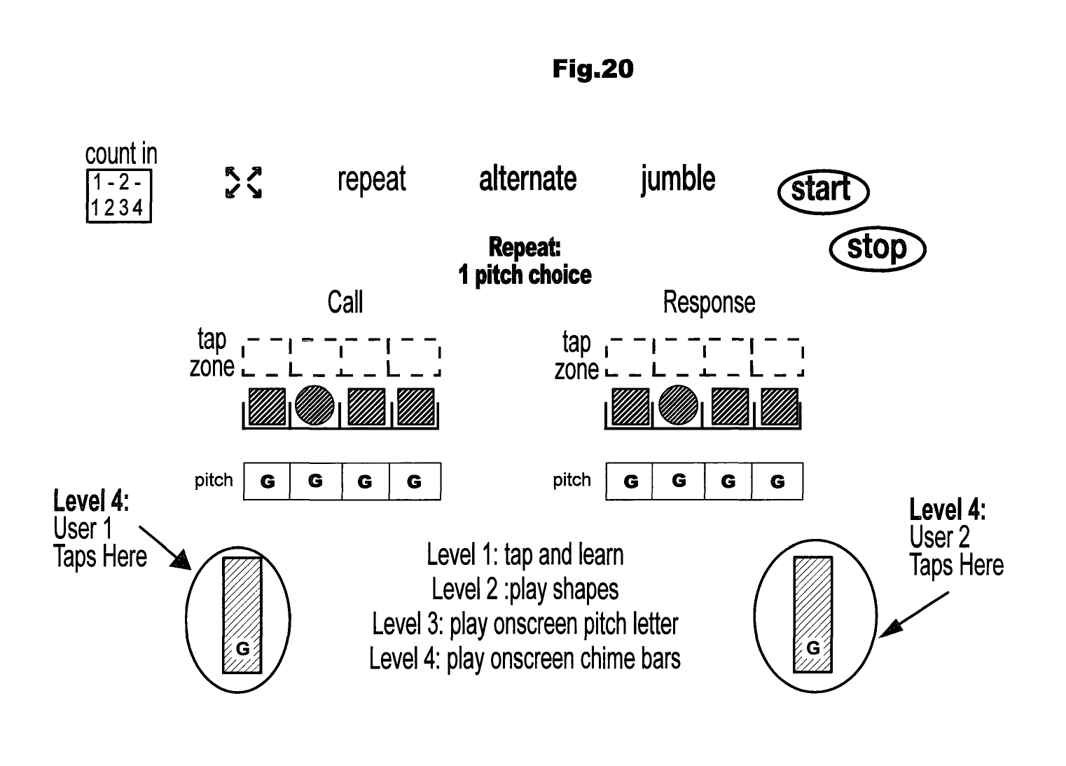

In “Level 1”—see FIG. 17—each participant taps once per box in the tap zone. In “Level 2”—see FIG. 18—each participant taps the correct rhythm onto the shape notation. In “Level 3”—see FIG. 19—each participant taps the correct pitch letter. In “Level 4”—see FIG. 20—each participant taps the on screen instrument. In “Level 5” (not illustrated) each participant plays an off screen instrument and in “Level 6” (also not illustrated) each participant plays an off screen instrument to conventional musical notation.

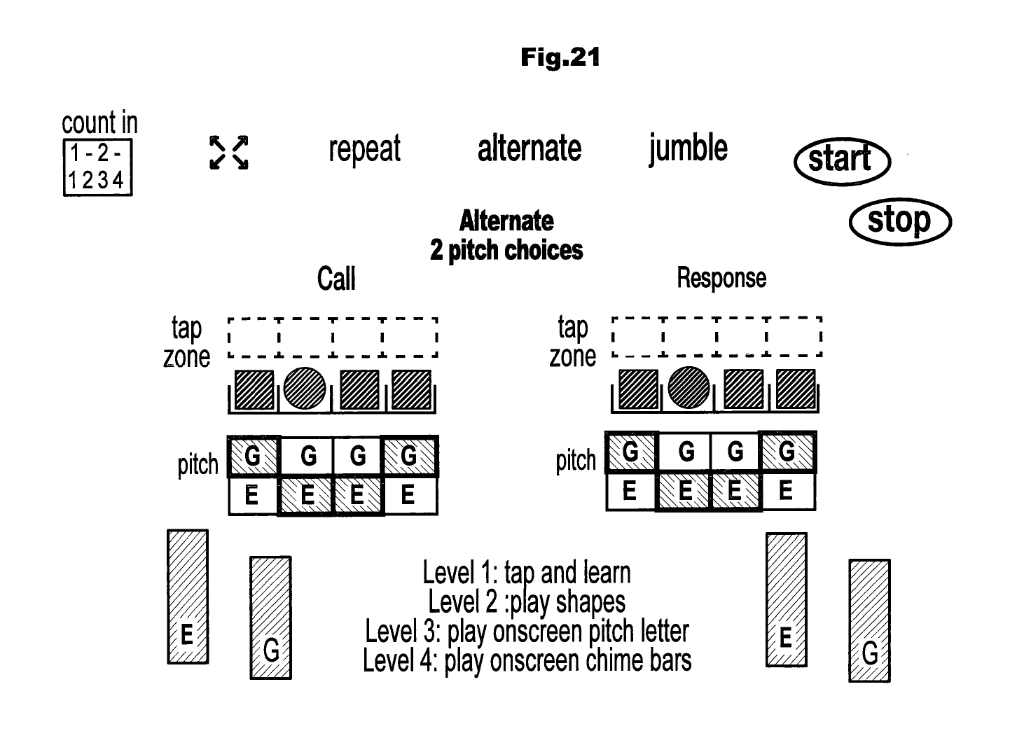

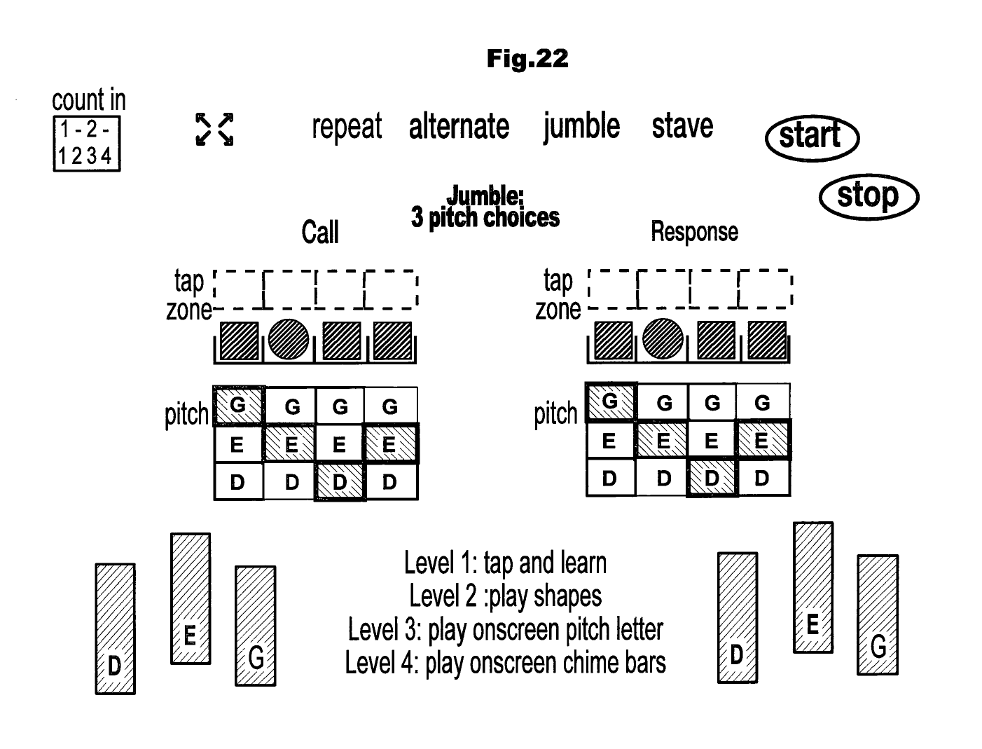

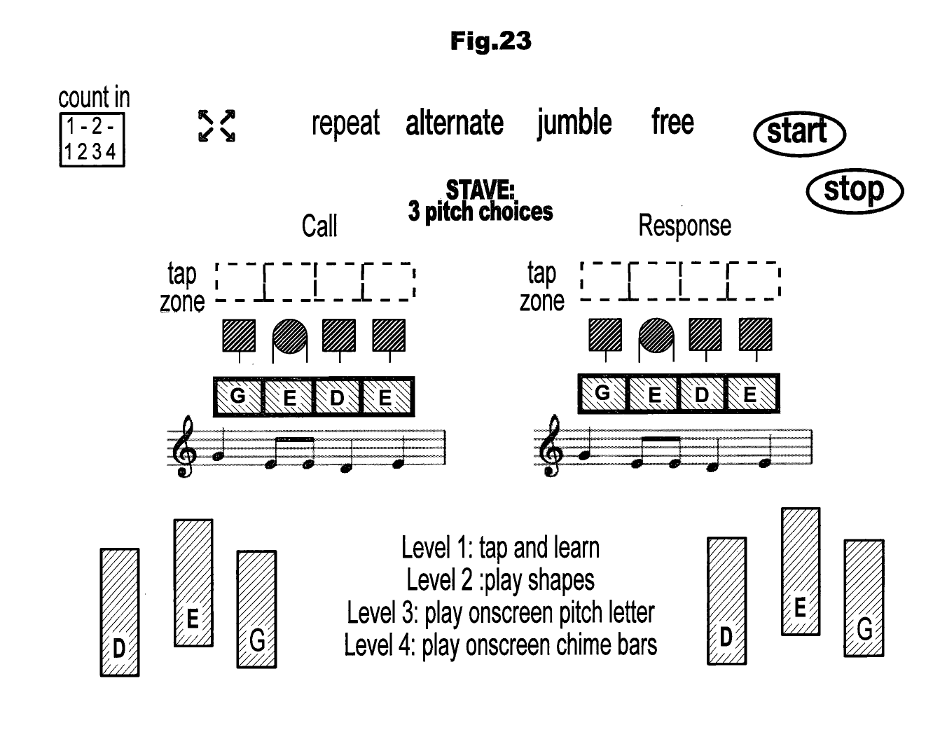

With two pitch choices—see FIG. 21—the mode is referred to as “Alternate”, and with three pitch choices—see FIG. 22—the mode is referred to as “Jumble”. The “Jumble” mode (or indeed any other mode) can be displayed as conventional notation by pressing the “Stave” button—see FIG. 23.

Also within the present disclosure is presented a methodology whereby the quality of a composition is assessed by, say, a computer and given a series of scores.

One such score is a ‘clarity score’—influenced by the amount/number of repetitions, use of contrast and how different Idea B is from Idea A, and whether resolutions used in the right place i.e. end of phrases.

If Idea A is CIRCLE SQUARE SQUARE CIRCLE

and Idea B is SQUARE SQUARE CIRCLE SHH

the following table can be constructed:

TABLE 1

| Number In | Idea A | Idea B | Difference |
|---|---|---|---|
| Circles | 2 | 1 | 1 |
| Squares | 2 | 2 | 0 |
| Shh | 0 | 1 | 1 |

| | |
|---|---|
| Sound Diversity Total | 2 |

giving a measure of sound diversity.

Likewise, the following sound placement table can be constructed:

TABLE 2

| | | | Same = 0 |
|---|---|---|---|
| Beat | Idea A | Idea B | Different = 1 |
| 1 | Circle | Square | 1 |
| 2 | Square | Square | 0 |
| 3 | Square | Circle | 1 |
| 4 | Circle | Shh | 1 |

| | |
|---|---|
| Sound Placement Total | 3 |

giving a measure of sound placement. The relevant weighting of sound diversity and sound placement scores may be adjusted however a numerical measure of how different Idea A is from Idea B (and C and D and so on) may be determined.

The clarity score will increase if resolution ideas are used at the end of phrases and (in pitched composition) if the root pitch is used as the very last note of a phrase. NB For any pitch combination (e.g. G B and D) offered to a user for composing the root note (in this example G) will be identified for scoring purposes.

Another score is an ‘interest score’—which awards points when a variation idea (like A_{V}) is used. The score will be influenced by the number and placing of variations e.g. if the first or second occurrence of Idea A is an A_{V} that would lose points. As stated above, variations should occur at the end of phrases.

A ‘unity score’ is a score that balances against the sound diversity score. The composition will score points if there are common 2 beat sequences of shapes between (for example):

Intro and Idea A or B

Outro and Idea A or B

and Idea A and Idea B or C

If for example Square—Circle occurs in Idea A and the Intro then the composition score will increase. If the same link happens between Idea A and B the composition score will increase provided they are not in the same beats, when the sound placement score will be reduced.

The weightings of all these scores will be adjustable to create feedback scores (with accompanying breakdowns and explanations) that best give users an understanding of how they can improve their compositions.

For example, a user may be presented with the message that Your Clarity Score was 35/80. Reasons: Idea C shared 3 common sounds with Idea A with 2 of them on the same beat, ii) no resolution ideas were used, and iii) the first Phrase didn't end on the root pitch. Try changing these parts of your composition to increase your score. Most importantly then listen to the result and decide if you like it better!”

Explanatory text will explain that these scores do not relate to the entire set of factors that makes great music great and ultimately it is the composer's ears that make the final decisions BUT these scores provide very concrete feedback on many of the skills and tools composers need to learn to use to make their compositions and creativity skills better. The assessment also provides very clear suggestions on ways of altering a composition which may well make the composition more successful.

Embodiments of the present invention allow for improved quality of composition, and the foregoing allows one to objectively assess said quality.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers.

Further modifications and improvements may be added without departing from the scope of the invention herein described. For example, the shape notation described herein is a convenient teaching aid but may be replaced with any other notation in which indicia are used to represent audio sequences.

1. A method of generating an audio output comprising:
(a) providing one or more indicia representative of an audio sequence on a user interface;
(b) detecting one or more user interactions with the user interface in a physical space associated with the one or more indicia;
(c) determining whether a timing of the one or more user interactions corresponds to a timing of the audio sequence represented by the one or more indicia; and
(d) based on the determination, outputting the audio sequence as an audio output.

2. A method according to claim 1, further comprising repeating (b) to (d) for a predetermined number of audio sequences.

3. A method according to claim 1, wherein the user interface comprises a touch screen interface configured to display the indicia and receive the one or more user interactions.

4. A method according to claim 1, wherein the user interface comprises a display device to display the indicia and a separate input device to receive the one or more user interactions.

5. A method according to claim 1, wherein detecting one or more user interactions comprises detecting one or more taps within a predetermined area of the user interface.

6. A method according to claim 5, wherein detecting one or more user interactions comprises detecting one or more taps on or near the indicia.

7. A method according to claim 1, wherein the method further comprises comparing the timing of the one or more user interactions with the timing of the audio sequence and determining a score representative of a user timing accuracy.

8. A method according to claim 1, wherein the method further comprises outputting an audible backing track corresponding to the timing of the audio sequence.

9. A method according to claim 1, wherein the method further comprises providing an indicator on the user interface, said indicator appearing in the vicinity of the one or more indicia to indicate the timing of the audio sequence.

10. (canceled)

11. A method according to claim 1, wherein the user interface comprises a touch screen interface.

12. A method according to claim 1, wherein the user interface comprises a display device and an input device.

13. A method according to claim 12, wherein at least a portion of the touch screen displays a virtual musical instrument.

14. (canceled)

15. A method of generating an audio sequence comprising:
(a) displaying a user interface;
(b) receiving an arrangement of indicia representative of the audio sequence via the user interface;
(c) detecting one or more user interactions with the user interface in a physical space associated with the one or more indicia;
(d) determining whether a timing of the one or more the user interactions corresponds with the audio sequence represented by the one or more indicia; and
(e) based on the determination, outputting the audio sequence as an audio output.

16. A method according to claim 15, wherein, the method further comprises receiving an indication of one or more pitch values to be associated with the audio sequence represented by the indicia.

17. A method according to either of claim 15, wherein the method further comprises receiving one or more lyrics to be associated with the audio sequence represented by the indicia.

18. A method according to claim 17, wherein the method further comprises converting the indicia, the indicia and the pitch values, the indicia and the lyrics, or the indicia and the pitch values and the lyrics, into musical notation and displaying said musical notation on the user interface.

19. A computer-readable medium comprising program instructions which, when executed by at least one computer, cause the computer to perform a method comprising:
providing one or more indicia representative of an audio sequence on a user interface;
detecting one or more user interactions with the user interface in a physical space associated with the one or more indicia;
determining whether a timing of the one or more user interactions corresponds to a timing of the audio sequence represented by the one or more indicia; and
based on the determination, outputting the audio sequence as an audio output.

20. A computer-readable medium comprising program instructions which, when executed by at least one computer, cause the at least one computer to:
display a user interface;
receive an arrangement of indicia representative of the audio sequence via the user interface;
detect one or more user interactions with the user interface in a physical space associated with the one or more indicia;
determine whether a timing of the one or more the user interactions corresponds with the audio sequence represented by the one or more indicia; and
based on the determination, outputting the audio sequence as an audio output.

21. (canceled)
